(19) United States
(12) Patent Application Publication
(10) Pub. No.: US 2006/0176443 A1
(43) Pub. Date: Aug. 10, 2006

(54) Frame structure of eyeglasses and manufacturing method thereof

(76) Inventor: Titan Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/244,179

(22) Filed: Oct. 6, 2005

(30) Foreign Application Priority Data
Feb. 4, 2005 (TW) 94103668

(51) Int. Cl. G02C 1/00

(52) U.S. Cl. 351/60

(57) ABSTRACT

A frame structure of eyeglasses and a manufacturing method thereof that uses a flexible material in a plastic frame is disclosed. A central bridge portion of the frame structure of eyeglasses integrally couples with a flexible material by bi-feeds injection molding. The flexible material can also couple the flexible material integrally on the rims to contact the at least on lens and form a flexible portion. Therefore, the rigidity of the frame structure is lessened and the flexibility between the two ends of the frame structure is increased, thereby enhancing the wearer's comfort. In another embodiment of the invention, the at least one lens are further designed with cushioning to provide shock proofing for avoiding any damage occurring to the glasses if they suffer an impact.

### BACKGROUND OF THE INVENTION

1. Field of the Invention

The present invention relates to a frame structure of eyeglasses and a manufacturing method thereof, and particularly to a method for manufacturing a frame of eyeglasses that uses bi-feeds injection molding, and a frame of eyeglasses that according to the manufacturing method thereof, improves the elasticity of the frame of eyeglasses and protects the lenses of the eyeglasses.

2. Description of the Prior Art

Most eyeglasses worn today are not worn only for improving the eyesight of the wearer, but also as an accessory to enhance the attractiveness of the wearer. Regardless of why they are worn, most eyeglass wearers desire a pair of eyeglasses that are comfortable to wear and protect the lenses of their eyeglasses.

Different types of eyeglass frames can substantially be divided into three kinds: a plastic frame, a metallic frame and frameless. The frameless type is very light for wearers and reduces the load of wearing eyeglasses. However, it lacks protection for the lenses and the lenses are easily broken if they fall off. The metallic frame kind has the advantage of firmness and the weight can be reduced if a light metallic substance is used. However the metallic frame is very rigid, lacks much ability to absorb impact and provides little protection for the lenses. Although some prior art has provided a plastic plate between the rims and the lenses for elastically holding the lenses and absorbing some of the shock to the lenses experienced in a fall, this method is not widespread due to its inconvenient design. The plastic frame has the advantages of being cheap, light and impact-resistant. However, the central bridge portion is usually very rigid and there is a lack of elasticity between the two ends.

Hence, the frame for eyeglasses of the prior art still has some inconveniences and disadvantages in terms of their comfort and ability to absorb impact that can be overcome.

### SUMMARY OF THE INVENTION

An objective of the present invention is to provide a frame structure of eyeglasses and a manufacturing method thereof, in which a central bridge portion of the frame of eyeglasses integrally couples with a flexible material, formed through bi-feeds injection molding. This structure and method of manufacture lessens the rigidity and increases the flexibility between the two ends of the frame and enhances the comfort level of the wearer.

Another objective of the present invention is to provide a frame structure of eyeglasses and a manufacturing method thereof that further couples the flexible material integrally on the rims so that they contact the lenses thereby providing the lenses with a greater ability to absorb shock.

In order to achieve the above objectives, the present invention, according to one aspect thereof, provides a manufacturing method for a frame structure of eyeglasses comprising of the following steps: a hard plastic frame is provided and has a bridge portion formed at a central portion thereof; a part of the bridge portion of the plastic frame is reduced; a flexible portion is coupled closely to the bridge portion of the plastic frame.

In order to achieve the other objective, the present invention, according to one aspect thereof, provides a manufacturing method for a frame of eyeglasses further comprising of the following steps: a plurality of through holes are formed in two side rims of the hard plastic frame; a flexible material is provided to pass through at least one of the through holes; the flexible portion is formed on the rims to contact the lenses. In order to achieve the above objectives, the present invention provides a frame structure of eyeglasses comprising of a hard plastic frame and at least one flexible portion. The hard plastic frame is formed by a first feed injection molding with a hard plastic. The hard plastic frame has a bridge portion, a pair of rims formed at two sides of the bridge portion, and a plurality of openings for a flexible material to flow through via a second feed injection molding. At least one flexible portion is formed by the second feed injection molding and integrally coupled with the hard plastic frame. The flexible portion is formed in the openings of the bridge portion and extends to a front surface of the hard plastic frame.

### BRIEF DESCRIPTION OF THE DRAWINGS

FIG. 1 is a flow chart of a manufacturing method for a frame of eyeglasses according to the present invention;

FIG. 2 is a front view of a frame structure of eyeglasses according to the present invention;

FIG. 3 is a front view of the hard plastic frame of the frame of eyeglasses of the second embodiment according to the present invention;

FIG. 3A is a front view of the hard plastic frame of the frame of eyeglasses of the third embodiment according to the present invention;

FIG. 4 is a front view of the frame of eyeglasses according to the present invention;

FIG. 4A is a front view of the frame structure of eyeglasses of the second embodiment according to the present invention;

FIG. 4B is a front view of the frame structure of eyeglasses applied in a lateral-I type frame according to the present invention;

FIG. 5 is a perspective view of a frame structure of eyeglasses applied in a full-type plastic frame according to the present invention;

FIG. 6 is a perspective view of the frame structure of eyeglasses of the full-type frame embodiment according to the present invention;

FIG. 6A is a partial magnified view of A part in FIG. 6; and

FIG. 6B is a partial magnified view of a part of another embodiment of FIG. 6.

### DESCRIPTION OF THE PREFERRED EMBODIMENT

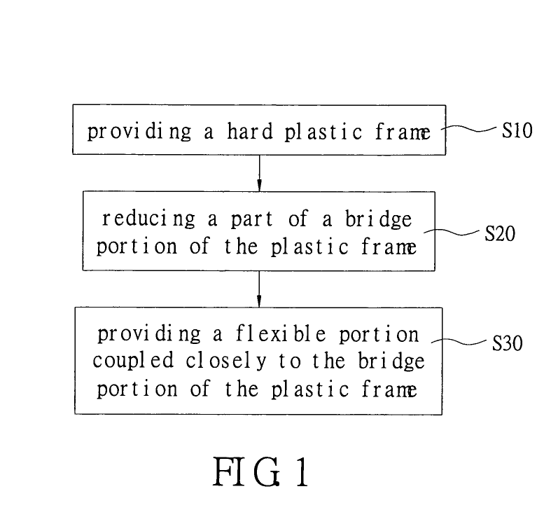

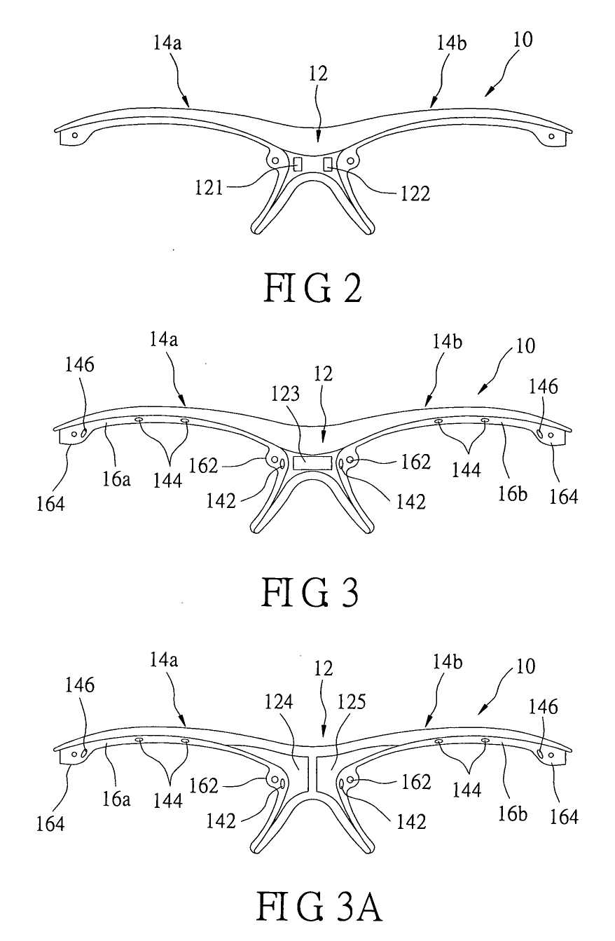

Reference is made in FIG. 1, which is a flow chart of a manufacturing method for a frame of eyeglasses according to the present invention. FIG. 2 is a front view of a frame structure of eyeglasses according to the present invention. The present invention provides a manufacturing method for a frame of eyeglasses. The method applies bi-feeds injection molding and includes the following steps:

As shown in step 10, a hard plastic frame 10 is first provided. The plastic frame has a bridge portion formed at a central portion thereof.

Then, as shown in step 20, a part of the bridge portion of the plastic frame is reduced.

As shown in FIG. 2, at least two through grooves 121 and 122 are formed at the bridge portion 12 of the hard plastic frame 10. The grooves 121 and 122 are not limited in their shape or design, however in the embodiments shown in FIGS. 2-3A the grooves are either enclosed by the hard plastic frame structure or not enclosed.

Lastly is step 30, a flexible portion 20 is provided and coupled closely to the bridge portion 12 of the hard plastic frame 10. The flexible portion 20 passes through the at least two through grooves 121 and 122.

The main characteristic of the present invention is that the hard plastic frame 10 is coupled with flexible material; in particular the bridge portion 12 is coupled with the flexible material. By partially reducing a part of the bridge portion 12 lessens the rigidity between the two ends of the hard plastic frame 10. Moreover, by adding the flexible material the flexibility of the structure is increased.

The best mode of the presented manufacturing method for a frame of eyeglasses is achieved by using a bi-feeds injection molding technology, so that the flexible material is integrally coupled with the hard plastic frame 10. However, the present invention is not limited to this mode. An alternative mode can, for example, insert a preformed flexible portion into the through grooves 121 and 122 of the hard plastic frame 10, binding them to each other. This is an obvious extension of the present invention. Using the bi-feeds injection molding method, the flexible material integrally couples with the hard plastic frame 10, thereby forgoing the need for any manual assembly, allowing for a mass production method that only requires a machine to produce the frame structure.

The bi-feeds injection method utilizes a first fixed half mold, a first movable half mold, a second fixed half mold and second movable half mold. Two molds are produced simultaneously. A first step uses the bi-feeds injection molding method to produce an unfinished frame structure. The first fixed half mold contacts with the first movable half mold and the second fixed half mold contacts with the movable second movable half mold. After the unfinished frame structures are shaped and cooled, the first movable half mold separates from the first fixed half mold and the second movable half mold separates from the second fixed half mold thereby exposing the unfinished frame structures. The unfinished frame structures (made of hard plastic) are retained in the fixed molds and any remnants are removed. In the second step, the movable molds turn 180 degrees so that first molds are contacted by the second molds. (The second movable half mold contacts the first fixed half mold and the first movable half mold contacts the second fixed half mold.) The unfinished frame structure is then injected with a flexible material. The above-mentioned steps can produce two molds continuously. However, the flexible material can be finished independently at another time.

In other words, the preferred manufacturing method for the present invention includes the following steps:

A first mold is provided and injected with a hard plastic material therein to form the hard plastic frame 10. A part of the bridge portion 12 of the hard plastic frame 10 is reduced simultaneously. For example, the bridge portion 12 is formed with the through grooves 121 and 122.

Then, a second mold is provided, wherein the hard plastic frame is remained therein; a flexible material is injected to form the flexible portion 20 and couple with the bridge portion 12 of the hard plastic frame 10. During manufacturing processes, the melted material is injected from back to front.

The through grooves 121 and 122 allow the melted flexible material to flow through and extend to a front surface of the hard plastic frame 10.

The present invention provides an improved frame of eyeglasses as shown in FIG. 2 by providing the manufacturing method for the frame structure. The frame structure comprises the hard plastic frame 10 made of hard plastic and the flexible material combined with the hard plastic frame 10. The hard plastic frame 10 includes the bridge portion 12 and a pair of rims 14a and 14b formed at two sides of the bridge portion 12. The bridge portion 12 is formed with at least one through groove that passes through the hard plastic frame 10 and allows the flexible material to combine with the hard plastic frame. In the embodiment shown in FIG. 1, the hard plastic frame 10 is a half-type plastic frame while the bridge 12 of the hard plastic frame 12 has two grooves 121 and 122.

When manufacturing the frame of eyeglasses, a width of the bridge portion 12 (meaning the shortest distance between two lenses according to the eyeglasses optical boxing system) is usually 10 mm to 28 mm for children, and 16 mm˜36 mm for adults. In the present invention, a ratio percentage of the flexible portion 20 to the bridge portion 12 is 10% to 90%. In practical consideration for the manufacturing process, the ratio percentage of the flexible portion 20 to the bridge portion 12 is usually over 30%.

Reference is made to FIG. 3, which is a front view of the hard plastic frame of the frame of eyeglasses of the second embodiment according to the present invention. The manufacturing method for the frame of eyeglasses further comprises of the following steps:

A plurality of through holes 144 are formed in the two side rims 14a and 14b of the hard plastic frame 10.

A flexible material is provided to pass through at least one through hole 144 to form the flexible portion on the rims 14a and 14b to contact with the lenses. The color of the flexible portion can be the same as or different from that of the hard plastic frame 10.

According to the above-mentioned description, another characteristic of the present invention provides a plurality of through portions. The flexible material can also be combined with the rims 14a and 14b of the hard plastic frame 10 by extending the flexible material through the through portions during a second feed injection molding, thereby offer greater protection for the lenses.

The number or shape of the through portions of the hard plastic frame 10 is not fixed. The embodiment of FIG. 3 shows the hard plastic frame 10 formed with many of through holes. Moreover, a groove 123, larger than the groove 122 shown in FIG. 2, is formed on the bridge portion 12. For example, the rims 14a and 14b are respectively formed with a through hole 142 adjacent to the bridge portion 12, two through holes 144 are disposed on a central part of the rims 14a and 14b and a through hole 146 is disposed at an end part of the rims 14a and 14b. The through hole can be thin and long. Therefore, the present invention not only combines the flexible portion 20 at the bridge portion 12 for reducing the rigidity of the frame structure, but also combines with the rims 14a and 14b for adding and additional protective feature for the lenses.

Please refer to FIG. 3A, which is a front view of the hard plastic frame of the frame of eyeglasses of the third embodiment according to the present invention. The bridge portion 12 can have many alterable shapes, as shown in this embodiment, which is substantially I-shaped with a pair of grooves 124 and 125 formed therein. The flexible portion covers the I-shaped bridge portion.

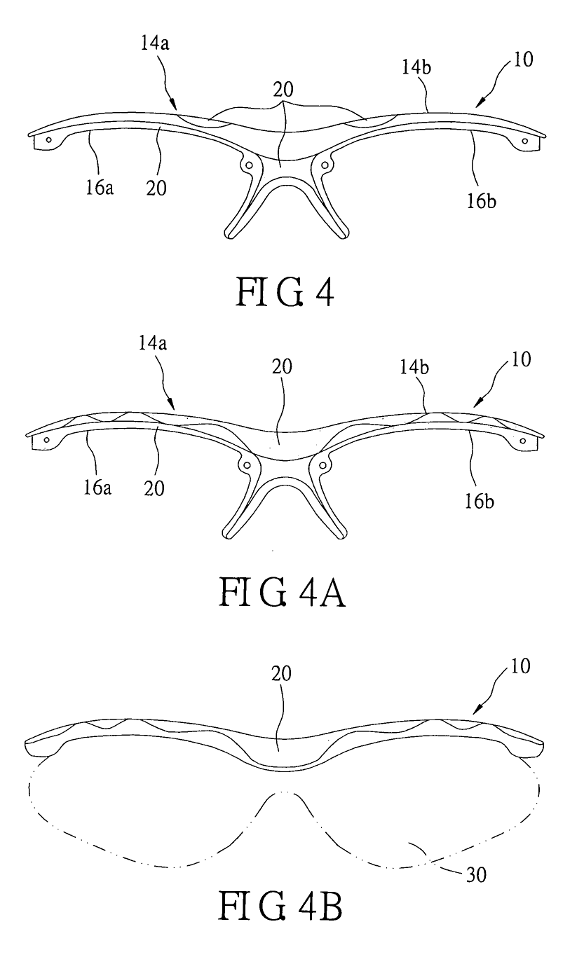

Please refer to FIG. 4, which is a front view of the frame of eyeglasses according to the present invention. This figure shows the present invention integrally combining the flexible material with the hard plastic frame 10 to form the flexible portion 20. In this embodiment, the flexible portion 20 extends from a rear surface of the bridge portion 12 to a front surface along the groove 123, and spreads to a front surface of the bridge portion 12 of the hard plastic frame 10. The flexible portion 20 further extends to cover entirely the inner edge of the rims 14a and 14b. However, the flexible portion 20 can be formed partially on the two rims 14a and 14b of the hard plastic frame 10.

The bridge portion 12 combines with the flexible material thereby increasing the flexibility between the two ends of the frame of eyeglasses, lessening the rigidity and enhancing the comfort level of the wearer. Moreover, the hard plastic frame 10 can have variable appearances and improves their aesthetic appearance by adding the flexible material that is different from the hard plastic frame 10. The proportion of the flexible portion 20 to the bridge portion 12 (hard plastic part) can be 10% to 90%. As to the arrangement of colors, clear or oblique colors or any configuration between both, or a gradual mixing of colors in transitional portions, can be produced. By disposing the flexible portion 20 at a contact portion between the rims and the lenses, a shockproof function is provided for the lenses, thereby protecting the lenses from damage, especially when the lenses are secured to the frame structure or they suffer an impact.

In the above embodiment, the rims 14a and 14b of the hard plastic frame 10 have fixing walls 16a and 16b protruding respectively from a lower edge thereof for fixing the lenses. Each of the fixing walls 16a and 16b are formed with at least one pair of locking blocks 162 and 164. The flexible portion 20 can only be formed on a front surface of the locking blocks 162 and 164, or formed on a front surface to cover entirely the fixing walls 16a and 16b.

Please refer to FIG. 4A, which is a front view of the frame structure of eyeglasses of the second embodiment according to the present invention. In this embodiment, the flexible portion 20 extends partially to an upper part of a front surface of the hard plastic frame 10 in a curved manner.

Please refer to FIG. 4B, which is a front view of the frame structure of eyeglasses applied in a lateral-I type frame according to the present invention. The figure shows the present invention can be applied in a lateral-I type frame, which has a hard plastic frame 10 with a shape of a lateral-I. The flexible portion 20 is partially formed on the lateral-I-shaped hard plastic frame 10 for increasing the frame structure's integral flexibility and protecting the lenses. A one-piece type lens 30 is embedded in a bottom slot of the lateral-I-shaped hard plastic frame 10.

There is one other feature of this embodiment that deserves to be mentioned. This is the flexible portion 20 able to be formed on a central part of the two sides of the hard plastic frame 10, i.e. the part that extends through the hard plastic frame 10 and contacts the lenses. Its design provides the lenses 30 with greater shockproof and cushioning functions so that they can absorb shock better. Even the flexible portion 20 extends into the bottom slot for clipping the lenses more flexibly and securely.

According to the above-mentioned design, the present invention can be applied in a full-type plastic frame. Please refer to FIG. 5, which is a perspective view of a frame structure of eyeglasses applied in a full-type plastic frame according to the present invention. This figure shows a hard plastic frame 10′ having a bridge portion 12′ and a pair of lens rims 14′. The lens rims 14′ of the hard plastic frame 10′ are respectively concaved with a fixing groove 140 for fixing the lenses. The bridge portion 12′ is formed with a pair of grooves 125 and 126. The rims 14′ are formed with a plurality of through holes 148 adjacent to the fixing groove 140.

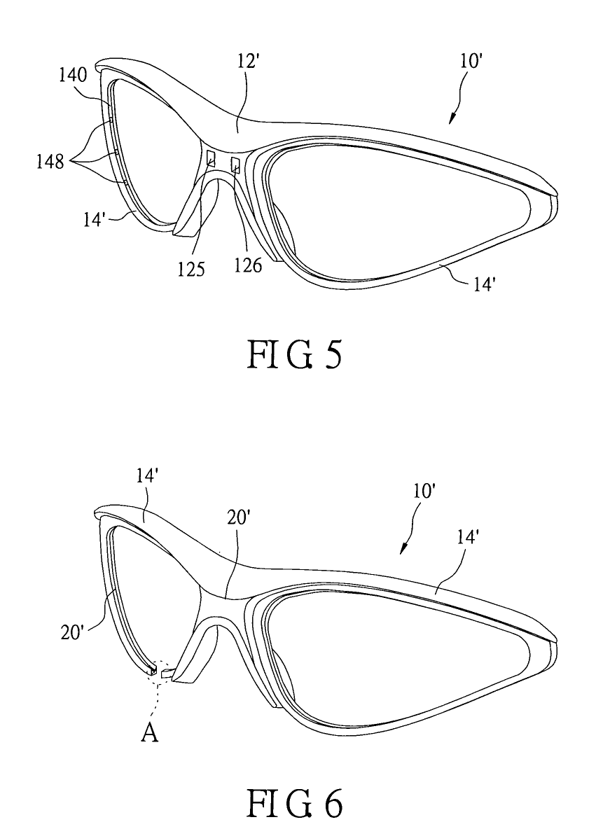

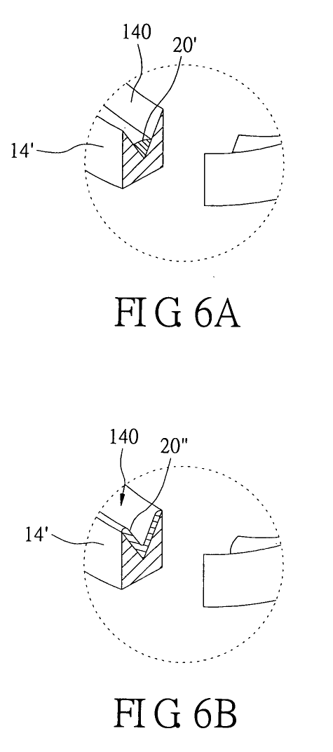

Reference is now made to FIG. 6 and FIG. 6A, which is a perspective view of the frame structure of eyeglasses of a full-type frame embodiment according to the present invention and a partial magnified view of A part in FIG. 6. In this embodiment, a flexible portion 20′ is formed in the groove 140 of the rims 14′ and the bridge portion 12′. The flexible portion 20′ provides the frame of eyeglasses with better flexibility and an improved protection for the lenses.

Reference is now made to FIG. 6B, which is a partial magnified view of a part of another embodiment the embodiment shown in FIG. 6. This figure shows the groove 140 of the lens rims 14′ that are covered entirely by the flexible portions 20″. The above-mentioned frame structure of eyeglasses of the full-type frame embodiment extends the flexible portions on an upper portion of a front surface of the hard plastic frame 10 in a curved manner as shown in FIG. 4a.

To sum up, the advantages and functions of the present invention are as followed:

1. The frame structure of eyeglasses of the present invention integrally couples a flexible material with a hard plastic frame by bi-feeds injection molding, thereby increasing the integral flexibility and enhancing the comfort level of the wearer. Moreover, it enhances the overall appearance of the eyeglasses.

2. The frame structure of eyeglasses of the present invention further couples the flexible material integrally on to the rims to contact the lenses, thereby providing the lenses with a shockproof function.

It is to be understood, however, that even though numerous characteristics and advantages of the present invention have been set forth in the foregoing description, together with details of the structure and function of the invention, the disclosure is meant to be illustrative only, and changes may be made in detail, especially in matters of shape, size, and arrangement of parts within the principles of the invention to the full extent indicated by the broad general meaning of the terms in which the appended claims are expressed.

What is claimed is:

1. A manufacturing method for a frame of eyeglasses, comprising the steps of:
providing a hard plastic frame, the plastic frame having a bridge portion formed at a central portion thereof;
reducing a part of the bridge portion of the plastic frame; and
providing a flexible portion coupled closely to the bridge portion of the plastic frame.

2. The manufacturing method for the frame of eyeglasses as in claim 1, wherein the bridge portion of the frame of eyeglasses has at least one through groove formed thereon, and the flexible portion passes through the groove.

3. The manufacturing method for the frame of eyeglasses as in claim 2, wherein the bridge portion of the frame of eyeglasses is substantially I-shaped, and the flexible portion covers the I-shaped bridge portion.

4. The manufacturing method for the frame of eyeglasses as in claim 1, wherein the flexible portion is integrally coupled with the hard plastic frame by bi-feeds injection molding technology.

5. The manufacturing method for the frame of eyeglasses as in claim 4, further comprising the steps of:
providing a first mold;
injecting a hard plastic material to form the hard plastic frame; and
reducing a part of the central bridge portion of the hard plastic frame.

6. The manufacturing method for the frame of eyeglasses as in claim 5, further comprising the steps of:
providing a second mold and disposing the hard plastic frame therein; and
injecting a flexible material into the hard plastic frame to form the flexible portion and couple with the hard plastic frame.

7. The manufacturing method for the frame of eyeglasses as in claim 1, further comprising the steps of:
forming a plurality of through holes in two side rims of the hard plastic frame;
providing a flexible material to pass through the at least two through holes; and
forming the flexible portion on the rims to contact at least one lens;

8. The manufacturing method for the frame of eyeglasses as in claim 1, wherein a color of the flexible portion is the same as or different from that of the hard plastic frame.

9. A frame structure of eyeglasses, comprising:
a hard plastic frame, formed by first feed injection molding with a hard plastic, the hard plastic frame having a bridge portion, a pair of rims formed at two sides of the bridge portion, and a plurality of openings for a flexible material to flow through for a second stage of feed injection molding;
at least one flexible portion, formed by the second stage of feed injection molding and integrally coupled with the hard plastic frame, the flexible portion forms in the openings of the bridge portion and extends to a front surface of the hard plastic frame.

10. The frame structure of eyeglasses as in claim 9, wherein the through openings include a groove formed on the bridge portion.

11. The frame structure of eyeglasses as in claim 10, wherein there is at least one groove formed on the bridge portion, and the grooves are enclosed.

12. The frame structure of eyeglasses as in claim 9, wherein there is at least one groove formed on the bridge portion, and the grooves are open.

13. The frame structure of eyeglasses as in claim 9, wherein the through opening comprises a plurality of through holes formed on the rims, and the flexible portion passes through the through holes and contacts the rims and the at least one lens.

14. The frame structure of eyeglasses as in claim 9, wherein the hard plastic frame is a half-type plastic frame.

15. The frame structure of eyeglasses as in claim 14, wherein each of the rims of the plastic frame has a fixing wall protruding from a lower edge thereof, each of the fixing walls is formed with at least a pair of locking blocks, and the flexible portion is formed on a front surface of the locking blocks.

16. The frame structure of eyeglasses as in claim 15, wherein the flexible portion is formed on a front surface of the fixing walls.

17. The frame structure of eyeglasses as in claim 9, wherein the hard plastic frame is a full-type plastic frame.

18. The frame structure of eyeglasses as in claim 17, wherein the rims of the hard plastic frame are concaved with a fixing groove for fixing the at least one lens, and the flexible portion is formed in the fixing groove.

19. The frame structure of eyeglasses as in claim 9, wherein a ratio percentage of the flexible portion to the bridge portion is 10% to 90%.
